(19) United States
(12) Patent Application Publication
(10) Pub. No.: US 2021/0006558 A1
(43) Pub. Date: Jan. 7, 2021

(54) METHOD, APPARATUS AND SYSTEM FOR PERFORMING AUTHENTICATION USING FACE RECOGNITION

(71) Applicant: Dream Security Co., Ltd., Seoul (KR)

(72) Inventor: Jin-Woo Jung, Gwangju-si (KR)

(21) Appl. No.: 16/783,995

(22) Filed: Feb. 6, 2020

(30) Foreign Application Priority Data
Jul. 4, 2019 (KR) 10-2019-0080569

(51) Int. Cl. H04L 29/06; H04W 12/06; G06K 9/00

(52) U.S. Cl. CPC H04L 63/0861; H04W 12/06; G06F 8/61; G06K 9/00288; H04L 63/0884

(57) ABSTRACT

Disclosed herein are a method, an apparatus and a system for performing authentication using face recognition. According to one aspect of the present disclosure, face authentication for a user is performed through interworking between the mobile terminal of the user and the face authentication server of an organization. Based on the result of performing face authentication, other devices in the face authentication system may be controlled through the mobile terminal or the like, and management of the user, such as monitoring attendance thereof and the like, may be processed by a management server.

### CROSS REFERENCE TO RELATED APPLICATION

This application claims the benefit of Korean Patent Application No. 10-2019-0080569, filed Jul. 4, 2019, which is hereby incorporated by reference in its entirety into this application.

### BACKGROUND

The following embodiments relate generally to a method, an apparatus and a system for performing authentication using face recognition, and more particularly to a method for providing an authentication service to a user through interworking between the mobile terminal of the user and a face authentication and control system.

Authentication methods such as fingerprint recognition are being widely used in order to authenticate specific people. As such authentication methods become popular, the following problems occur:
a delay caused when clocking in and out: When a large number of employees simultaneously attempts to authenticate themselves through fingerprint recognition at a specific time, for example, at the start of work, a problem of time delay may be caused due to authentication. Because multiple employees sequentially scan their fingerprints using a fingerprint sensor one by one, much time is spent clocking in.
fingerprint recognition error and fingerprint theft: When a fingerprint of a user wears down, when the hand of the user is wet, or when the finger of the user is cut, it may be impossible to recognize the fingerprint. Also, the fingerprint of a specific person may be stolen and used illegally by replicating the fingerprint using silicone.
erroneous detection of a fingerprint: In the process of patterning a fingerprint, the scanned fingerprint may be erroneously detected due to the same pattern or a similar pattern.

Accordingly, a new authentication method for solving the above problems with the conventional authentication method is required. Particularly, reflecting the situation in which most individuals always carry and use mobile terminals such as smartphones, a method for providing an authentication service through interworking between the mobile terminal of a user and a face authentication and control system is required.

### BRIEF SUMMARY

An embodiment provides a face authentication platform based on a mobile terminal in an Internet-of-Things (IoT) environment.

An embodiment may provide a solution or service in which face authentication for individuals is required in a company, an organization, a school, or an educational institute in order to provide employee attendance management, visitor control for preventing visitors from entering a building, issuance of meal tickets in a cafeteria, lock/unlock of an electronic locker, and the like.

In an aspect, there is provided an authentication method in which the mobile terminal of a user performs authentication for the user by operating in conjunction with a face authentication and control system. The authentication method may include generating face information for the user by capturing an image of the user, transmitting authentication request information including the face information to a face authentication server, and receiving face authentication result information from the face authentication server, the face authentication result information representing the result of face authentication performed for the user.

In another aspect, there is provided an authentication method in which a face authentication and control system performs face authentication for a user by operating in conjunction with the mobile terminal of the user. The authentication method may include receiving, by a face authentication server, authentication request information including face information about the face of the user of the mobile terminal from the mobile terminal; performing, by the face authentication server, face authentication for the user using the authentication request information; and generating, by the face authentication server, face authentication result information for the face authentication and/or processing request information based on the result of the face authentication. The face authentication result information may be information representing the result of face authentication performed for the user, and the processing request information may be information for requesting management for the user and/or control of the face authentication and control system when the face authentication for the user succeeds.

Additionally, other methods, devices, and systems for implementing the present disclosure and a computer-readable recording medium for recording a computer program for implementing the above-described methods are further provided.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 illustrates a face authentication and control system according to an embodiment;

FIG. 2 illustrates a service provided by a face authentication platform that provides face authentication according to an example;

FIG. 3 illustrates the structure of a device according to an embodiment;

FIG. 4 is a schematic flowchart of a face authentication and control method according to an embodiment;

FIG. 5 is a flowchart of a method for preparing for face authentication according to an example;

FIG. 6 is a flowchart of a method for performing face authentication for a user according to an embodiment;

FIG. 7 illustrates a method for controlling a device of a system based on face authentication performed for a user according to an embodiment;

FIG. 8 illustrates location information displayed on a mobile terminal according to an example;

FIG. 9 illustrates system control information displayed on a mobile terminal according to an example;

FIG. 10 illustrates a motion instruction message for face recognition displayed on a mobile terminal according to an example;

FIG. 11 illustrates another motion instruction message for face recognition displayed on a mobile terminal according to an example;

FIG. 12 illustrates a face information check screen according to an example; and

FIG. 13 illustrates a screen on which a multiple face registration state is displayed according to an example.

### DETAILED DESCRIPTION

Specific embodiments will be described in detail below with reference to the attached drawings. These embodiments are described in sufficient detail to enable those skilled in the art to practice the present disclosure. It should be understood that the embodiments differ from each other, but the embodiments are not necessarily exclusive of each other. For example, a particular feature, structure, or characteristic described herein in connection with one embodiment may be implemented in another embodiment without departing from the sprit and scope of the present disclosure. Also, it should be understood that the location or arrangement of individual elements in the disclosed embodiments may be changed without departing from the spirit and scope of the present disclosure. Therefore, the following detailed description is not to be taken in a limiting sense, and if appropriately interpreted, the scope of the exemplary embodiments is limited only by the appended claims along with the full range of equivalents to which the claims are entitled.

The same reference numerals are used to designate the same or similar elements throughout the drawings. The shapes, sizes, etc. of components in the drawings may be exaggerated to make the description clear.

The terms used herein are for the purpose of describing particular embodiments only and are not intended to be limiting of the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element, or intervening elements may be present.

It will be understood that, although the terms “first,” “second,” etc. may be used herein to describe various elements, these elements should not be limited by these terms. These terms are only used to distinguish one element from another element. For instance, a first element discussed below could be termed a second element without departing from the teachings of the present disclosure. Similarly, a second element could also be termed a first element.

Also, element modules described in the embodiments of the present disclosure are illustrated as being independent in order to indicate different characteristic functions, but this does not mean that each of the element modules is formed of a separate piece of hardware or software. That is, element modules are arranged and included for convenience of description, and at least two of the element units may form one element unit or one element may be divided into multiple element units and the multiple element units may perform functions. An embodiment into which the elements are integrated or an embodiment from which some elements are separated is included in the scope of the present disclosure as long as it does not depart from the essence of the present disclosure.

Also, in the present disclosure, some elements are not essential elements for performing essential functions, but may be optional elements merely for improving performance. The present disclosure may be implemented using only essential elements for implementing the essence of the present disclosure, excluding elements used only to improve performance, and a structure including only essential elements, excluding optional elements used only to improve performance, is included in the scope of the present disclosure.

Hereinafter, embodiments of the present disclosure are described with reference to the accompanying drawings in order to describe the present disclosure in detail so that those having ordinary knowledge in the technical field to which the present disclosure pertains can easily practice the present disclosure. In the following description of the present disclosure, detailed descriptions of known functions and configurations that are deemed to make the gist of the present disclosure obscure will be omitted.

In the embodiments, the term “face” and the term “visage” may be used as having the same meaning, and may be used interchangeably with each other.

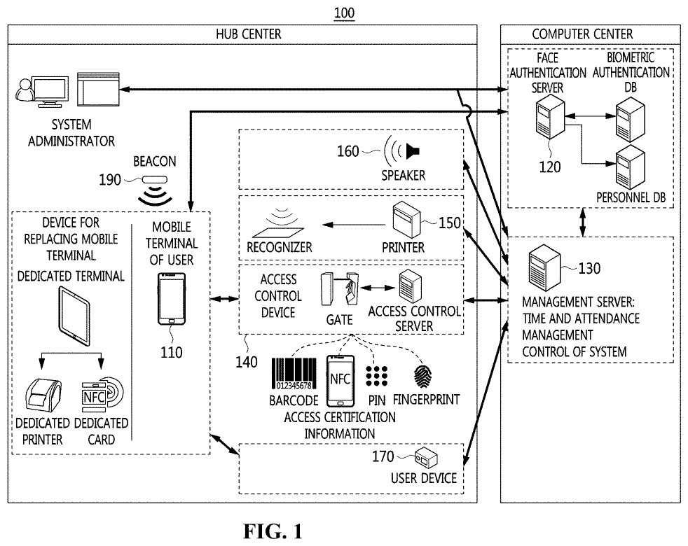

FIG. 1 illustrates a face authentication and control system according to an embodiment.

In FIG. 1, the components of the face authentication and control system 100 are illustrated, and the relationship therebetween is illustrated using an arrow. The arrow represents communication between the components and exchange or sharing of information therebetween.

Hereinbelow, the face authentication and control system 100 may be simply referred to as the system 100.

In FIG. 1, a hub center and a computer center are illustrated. The hub center may indicate a place, an area, a building, or the like in which the user of the system 100 or the like is located. The computer center may indicate a place, an area, a building, or the like in which servers for providing the face authentication and control service of the system 100 are located.

The system 100 may include a mobile terminal 110, a face authentication server 120, and a management server 130.

The mobile terminal 110 may be a device used by a user, other than the system 100. That is, the mobile terminal 110 may be regarded as a separate device that is not included in the system 100.

The face authentication server 120 may perform authentication for the user of the mobile terminal 110.

In order to provide information to the face authentication server 120 and to store information used in the face authentication server 120, the system 100 may further include at least some of a biometric authentication database (DB) and a personnel DB. The face authentication server 120 may perform face authentication for a user using the biometric authentication DB and the personnel DB. The personnel DB may provide basic information about users (for example, employees).

The management server 130 may perform user management using the result of face authentication. For example, the management server 130 may perform time and attendance management for users using the result of face authentication.

Also, the management server 130 may control other devices of the system 100 using the result of face authentication. As such devices controlled by the management server 130, the system 100 may further include at least some of an access control device 140, a printer 150, a speaker 160, and another user device 170.

The face authentication server 120 and the management server 130 may be operated by the same entity, or may be operated by different individual entities. For example, the face authentication server 120 may be managed by a company, an organization, or the like that provides an authentication service for users, and may provide a face authentication service for the management server 130.

Also, the system 100 may further include a recognizer for recognizing a printout generated by the printer 150.

Also, the system 100 may further include a beacon 190.

Also, as an alternative device for replacing the mobile terminal 110 of the user, the system 100 may include at least some of a dedicated terminal, a dedicated printer, and a dedicated card. For example, the dedicated printer may be a barcode printer for printing out a barcode. The dedicated card may be a nearfield communication (NFC) card for the access control device 140 and the user device 170.

Also, the system 100 may further include an administrative terminal managed by a system administrator.

Using the administrative terminal, the system administrator may perform real-time monitoring for the system 100 and tasks that require intervention on the part of the system administrator.

The access control device 140 may process the entry and exit of users using access certification information. The access certification information may include a barcode, an NFC signal, a personal identification number (PIN), or a fingerprint. The access certification information may be output to the mobile terminal 110, and the access control device 140 may process the entry and exit of the user by recognizing the access certification information displayed on the mobile terminal 110.

For example, the access control device 140 may include a gate and an access control server.

The user device 170 may perform an operation using system control information, which will be described later. For example, the user device 170 may be a personal locker, and the personal locker may be opened or closed using the system control information.

In an embodiment, the system control information and the access certification information may be the same as each other, but may be called different names depending on which device uses the corresponding information (the device may be, for example, the access control device 140 or the user device 170). Accordingly, in an embodiment, a description of the access certification information may be applied to the system control information.

The components of the system 100 and relationships therebetween will be described in detail below.

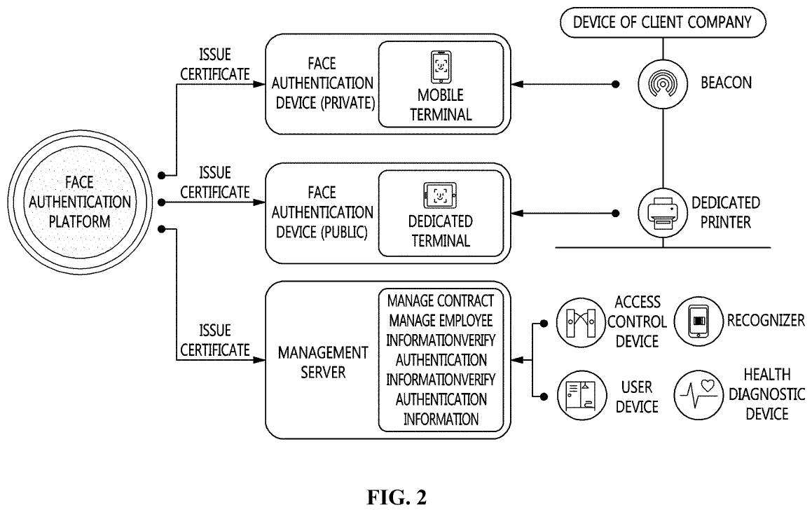

FIG. 2 illustrates a service provided by a face authentication platform that provides face authentication according to an example.

The face authentication platform may include the above-described face authentication server 120.

The face authentication server 120 may issue certificates to authentication devices for authentication. The authentication devices may include a personal face-authentication device, a public face-authentication device, and the management server 130. Using the certificate, the face authentication server 120 may operate in conjunction with other devices.

The personal face-authentication device may include the above-described mobile terminal 110 of a user.

The public face-authentication device may include the above-described dedicated terminal.

The management server 130 may perform user management. The management server 130 may be a client company management server managed by a client company that uses the face authentication platform.

For example, the management server 130 may function to manage a contract for a user, to manage employee information related to the user, and to (additionally) verify certification information pertaining to the user. Also, the management server 130 may manage a service provided to the user, such as foodservice management and the like.

The client company devices may operate in conjunction with the devices for authentication. The client company device may be an IoT device. The client company device may be managed by the client company that uses the face authentication platform.

The client company devices may include a beacon 190, a dedicated printer, an access control device 140, a recognizer, a user device 170, a health diagnostic device, and the like.

For example, the beacon 190 may operate in conjunction with the personal face-authentication device. The dedicated printer may operate in conjunction with the public face-authentication device. The access control device 140, the recognizer, the user device 170, the health diagnostic device, and the like may operate in conjunction with the management server 130.

The service provided by the face authentication platform and interworking between the components of the system 100 will be described in detail below.

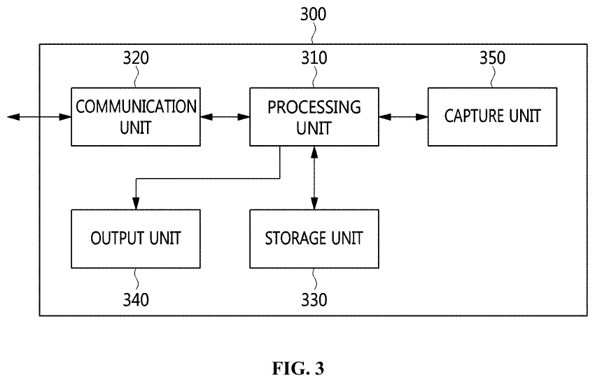

FIG. 3 illustrates the structure of a device according to an embodiment.

The device 300 may correspond to each of the components of the system 100 described above. For example, the device 300 may be one of the mobile terminal 110, the face authentication server 120, the management server 130, the access control device 140, the printer 150, the speaker 160, the user device 170, the beacon 190, the biometric authentication DB, the personnel DB, the dedicated terminal, the dedicated printer, the dedicated card, and the administrative terminal.

The device 300 may include at least some of a processing unit 310, a communication unit 320, and a storage unit 330 as the components thereof. The components may communicate with each other via one or more communication buses or signal lines.

The components illustrated as the components of the device 300 in FIG. 3 are merely examples. Not all of the illustrated components may be essential for the device 300. The device 300 may have a greater or smaller number of components than those illustrated in FIG. 3. Also, two or more of the components illustrated in FIG. 3 may be combined. Also, the components may be configured or arranged in a manner different from that illustrated in FIG. 3. Each of the components may be implemented in hardware, software, or a combination thereof, including one or more signal-processing and/or application-specific integrated circuits (ASICs).

The processing unit 310 may process a task required for the operation of the device 300. The processing unit 310 may execute code for operation of the processing unit 310 or steps described in embodiments.

The processing unit 310 may generate a signal, data or information, or may process a signal, data or information input to the device 300, output from the device 300, or generated in the device 300. Also, the processing unit 310 may perform checking, comparison, determination, and the like with respect to the signal, the data, or the information. That is, generation and processing of data or information and checking, comparison and determination with respect to the data or the information in an embodiment may be performed by the processing unit 310.

For example, the processing unit 310 may be at least one processor.

The processor may be a hardware processor, and may be a central processing unit (CPU). The processor may comprise multiple processors. Alternatively, the processor may include multiple cores, and may provide multi-tasking for simultaneously executing multiple processes and/or multiple threads. At least some of the steps in the embodiments may be performed in parallel for multiple targets through multiple processors, multiple cores, multiple processes and/or multiple threads.

For example, the processing unit 310 may execute code of the operation of the device 300 or steps described in embodiments.

For example, the processing unit 310 may run a program. The processing unit 310 may execute code of the program. The program may include the operating system (OS) of the device 300, a system program, an application, and an app.

Also, the processing unit 310 may control other components of the device 300 for the above-described functions of the processing unit 310.

The communication unit 320 may receive data or information that is used for the operation of the device 300, and may transmit data or information that is used for the operation of the device 300.

The communication unit 320 may transmit data or information to other devices in a network to which the device 300 is connected, or may receive data or information therefrom. That is, transmission or reception of data or information in an embodiment may be performed by the communication unit 320.

For example, the communication unit 320 may be a networking chip, a networking interface, or a communication port.

The network may include a wired network and a wireless network.

The storage unit 330 may store data or information that is used for the operation of the device 300. In an embodiment, data or information possessed by the device 300 may be stored in the storage unit 330.

For example, the storage unit 330 may be memory. The storage unit 330 may include internal storage media such as RAM, flash memory, and the like, and may include detachable storage media, such as a memory card and the like.

The storage unit 330 may store at least one program. The processing unit 310 may execute the at least one program. The processing unit 310 may read the code of the at least one program from the storage unit 330 and execute the read code.

The operations, functions, and characteristics of the processing unit 310, the communication unit 320, and the storage unit 330 of the device 300 will be described in detail below with reference to embodiments.

The device 300 may further include an output unit 340. The output unit 340 may output data or information of the device 300. Alternatively, the output unit 340 may be a component through which data or information output by the processing unit 310 is displayed.

The user of the device 300 may perceive the data or information output by the output unit 340.

The device 300 may further include a capture unit 350. The capture unit 350 captures an image of a target, thereby generating an image or video containing the target.

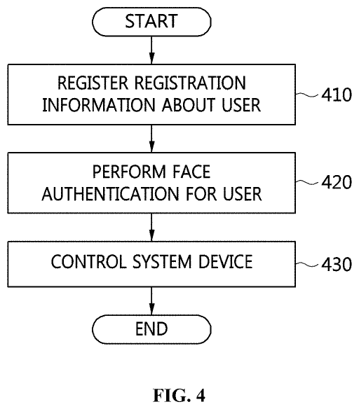

FIG. 4 is a schematic flowchart of a face authentication and control method according to an embodiment.

The face authentication and control method according to an embodiment may include steps 410, 420 and 430.

The method according to the embodiment may be a method in which the mobile terminal 110 of a user performs face authentication for the user by operating in conjunction with the face authentication and control system 100. Also, the method according to the embodiment may be a method in which the face authentication and control system 100 performs face authentication for a user by operating in conjunction with the mobile terminal 110 of the user.

Step 410 may be a preparation step for face authentication.

At step 410, the mobile terminal 110 of a user may register registration information pertaining to the user in the face authentication server 120.

Step 420 is a step for performing face authentication for the user through a face authentication process.

At step 420, the face authentication server 120 may perform face authentication for the user through information transmitted from the mobile terminal 110 of the user, and the management server 130 may manage the user based on face authentication performed for the user.

Step 430 is a step for controlling a target device of the system 100 as face authentication for the user is completed.

At step 430, the management server 130 may control the target device of the system based on face authentication performed for the user, and a specific function may be performed through interworking or interaction between the mobile terminal 110 and the controlled target device.

Each of steps 410, 420 and 430 will be described in detail below.

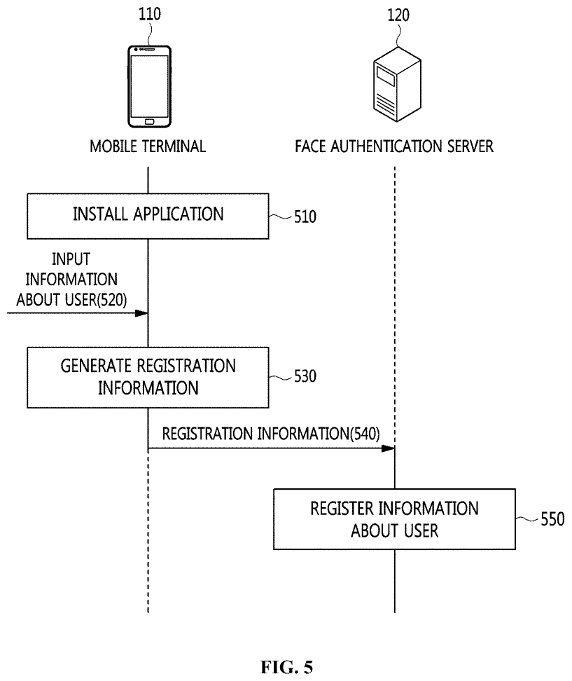

FIG. 5 is a flowchart of a method for preparing for face authentication according to an example.

Step 410, described above with reference to FIG. 4, may include the following steps 510, 520, 530, 540 and 550.

It may be required to install a dedicated application in the mobile terminal 110 in order to perform face authentication.

For example, a user goes to an office or a workplace, thereby arriving at a place at which face authentication by the system 100 is required. The administrator of the system 100, a guide, or a notice may instruct, recommend, or prompt the user to install the application in the mobile terminal 110, or may demonstrate the installation of the application.

At step 510, the application for face authentication may be installed in the mobile terminal 110.

The application may be a program that is used for face authentication. Hereinafter, the function described as being performed by the mobile terminal 110 may be regarded as being performed by the application. Alternatively, the function described hereinafter as being performed by the application may be regarded as being performed by the mobile terminal 110.

At step 520, the user of the mobile terminal 110 may input information about the user to the application. Through the application, the information about the user may be input from the user to the mobile terminal 110.

The information about the user may include the personal information of the user. The personal information may include the name, the address, the telephone number, and the like of the user.

The information about the user may include an image of the face of the user. Alternatively, the information about the user may include the path of a file containing the image of the face of the user. The application may identify the file using the input path and extract the image of the face of the user from the file.

At step 530, the application may generate registration information for face authentication using the input information about the user.

The registration information may be information that is used in order to register the user in the face authentication server 120.

The registration information may include the above-described personal information of the user, and may include an image of the face of the user.

At step 540, the mobile terminal 110 may transmit the registration information to the face authentication server 120. The face authentication server 120 may receive the registration information from the mobile terminal 110.

At step 550, the face authentication server 120 may register the information about the user of the mobile terminal 110 using the registration information.

Then, the face authentication server 120 may perform face authentication for the user using the registered information about the user.

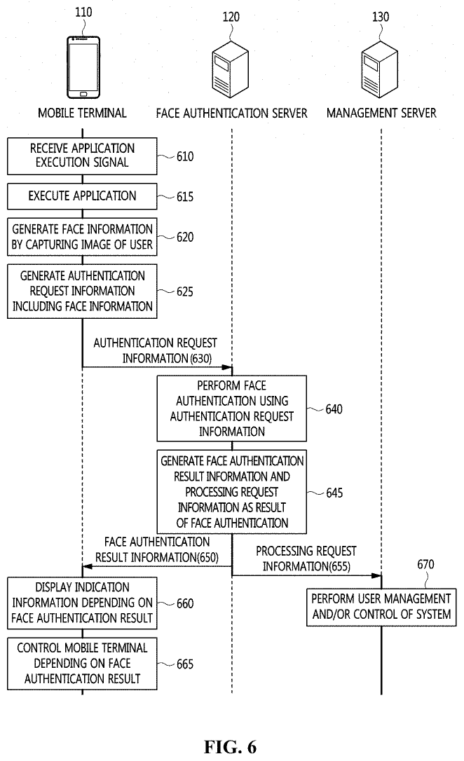

FIG. 6 is a flowchart of a method for performing face authentication for a user according to an embodiment.

Step 420, described above with reference to FIG. 4, may include the following steps 610, 615, 620, 625, 630, 640, 645, 650, 655, 660, 665, and 670.

At step 610, the mobile terminal 110 may receive an application execution signal.

For example, the application execution signal may be a beacon signal output from a beacon 190.

For example, the user of the mobile terminal 110 may move to a specific place in which the beacon 190 is installed. In the corresponding place, the beacon 190 may transmit a beacon signal. When the mobile terminal 110 enters a specific authentication area in which it is possible to receive a beacon signal, the mobile terminal 110 may receive a beacon signal from the beacon 190.

At step 615, upon receiving the application execution signal, the mobile terminal 110 may execute an application.

Upon receiving the application execution signal, the mobile terminal 110 may transmit an application execution message to the application.

For example, the application execution message may be a push message that is pushed to the application.

Through the execution message of the application, the application may be executed, and the application execution message may be transmitted to the application.

At step 620, the application may generate face information by capturing an image of the user.

The application may recognize the face of the user using the capture unit of the mobile terminal 110, and may generate an image or video by capturing the image of the face of the user using the capture unit.

The capture unit may be the camera of the mobile terminal 110. The camera may comprise multiple cameras. Also, the camera may be an infrared camera or a depth camera. Also, the multiple cameras may generate a 3D image, 3D video, a depth image, depth video, and the like.

For example, the image or video may be a 3D image, 3D video, an infrared image, infrared video, a depth image, and/or depth video generated through the functions of the cameras.

The application may generate face information about the face of the user through face recognition using an image or video.

In an embodiment, the face information may include facial feature point information pertaining to the face of the user. The facial feature point information may be information about the feature points in the face of the user, and may be information that represents the feature points in the face of the user.

The feature point may represent facial elements, such as the eyes, nose, mouth, and the like in the face of the user.

At step 625, the application may generate authentication request information including the face information.

The authentication request information may be information for requesting face authentication for the user of the mobile terminal 110 from the face authentication server 120, and may be information that is used for face authentication for the user.

The authentication request information may include the identifier of the user or the mobile terminal 110. For example, the identifier may be the identifier of the user, the social security number of the user, a number identifying the user and/or the phone number of the mobile terminal 110. The number identifying the user may be a number assigned to the user by a specific organization, such as an employee number.

The authentication request information may include the captured image or video.

At step 630, the mobile terminal 110 may transmit the authentication request information to the face authentication server 120. The face authentication server 120 may receive the authentication request information from the mobile terminal 110.

At step 640, the face authentication server 120 may perform face authentication for the user using the authentication request information.

For example, the face authentication server 120 may perform face authentication for the user by comparing the face information included in the authentication request information with the registration information pertaining to the user. The face authentication server 120 may verify whether the face information included in the authentication request information represents the face of the user through comparison with the registration information pertaining to the user.

For example, the face authentication server 120 compares the facial feature point information of the face information included in the authentication request information with the feature points of the face of the user acquired from the registration information pertaining to the user, thereby performing face authentication for the user.

For example, the face authentication server 120 compares the face information included in the authentication request information with multiple pieces of registration information pertaining to users registered in the system 100, thereby identifying the user represented by the face information included in the authentication request information, among the registered users.

For example, the face authentication server 120 compares the facial feature point information of the face information included in the authentication request information with the feature points of the faces of users acquired from the pieces of registration information of the users, thereby identifying the user represented by the face information included in the authentication request information, among the registered users.

At step 645, the face authentication server 120 may generate face authentication result information and/or processing request information with respect to face authentication based on the result of face authentication.

The face authentication result information may be information that represents the result of face authentication performed for the user. For example, the face authentication result information may represent whether face authentication for the user succeeds or fails.

The face authentication result information may include indication information. The indication information may be information to be output to the mobile terminal 110 of the user depending on whether face authentication for the user succeeds or fails.

For example, the indication information may represent an image having a specific purpose.

For example, the indication information may include user information that represents the name, the post, the identity, or the privileges of the user.

For example, the user information may be an employee ID card or a pass of the user.

For example, the employee ID card or the pass may include the photograph of the user or the thumbnail image of the user, which will be described later. Also, the employee ID card or the pass may include the symbol image or logo of the organization. The thumbnail image may be used to match the photograph of the user shown in the employee ID card or the pass with the actual appearance of the user.

For example, the indication information may include system control information, which is information for controlling a specific device of the system 100, such as the access control device 140, the user device 170, or the like.

That is, the system control information may be information that allows the user who is authenticated through face authentication to perform a specific action in a specific place.

For example, the system control information may represent a signal, a combination of numbers and letters, code, a symbol, an image, video, and the like output from the mobile terminal 110, and may be a 2D barcode or a Quick Response (QR) code. The specific device of the system 100 may perform a specific operation by recognizing the system control information output from the mobile terminal 110 using a camera, a scanner, a network, or the like.

For example, the system control information may include the identifier of the user. The specific device of the system 100 may identify the user who requests the operation through the identifier of the user included in the system control information.

For example, the system control information may be output via the display of the mobile terminal 110, and may be output through the communication unit of the mobile terminal 110, such as Wi-Fi, a mobile communication network, Bluetooth, NFC, or the like. The specific device of the system 100 may perform the specific operation by recognizing the system control information output from the mobile terminal 110 through the network.

For example, the system control information may be access certification information. The access certification information may be a barcode, an NFC signal, a PIN, a fingerprint, or the like. The access certification information may be used in order to control the access control device 140.

The face authentication result information may include terminal control information. The terminal control information may be information for controlling the mobile terminal 110 of the user depending on whether face authentication for the user succeeds or fails.

For example, the terminal control information may be information that indicates whether to enable or disable a specific function of the mobile terminal 110. The mobile terminal 110 may enable or disable the specific function thereof depending on the terminal control information.

The processing request information may be information for requesting the management for the user and/or control of the system 100 when face authentication for the user has succeeded.

For example, the processing request information may be information for requesting to process specific management for the user when face authentication for the user has succeeded.

For example, the processing request information may be information for requesting a specific device of the system 100, which is controlled by the management server 130, to perform a specific operation when face authentication for the user has succeeded. Here, the processing request information may indicate the specific device and the specific operation.

The face authentication result information and the processing request information may include face authentication time information. The face authentication time information may represent the time at which face authentication is performed.

At step 650, the face authentication server 120 may transmit the face authentication result information to the mobile terminal 110. The mobile terminal 110 may receive the face authentication result information from the face authentication server 120.

At step 655, the face authentication server 120 may transmit the processing request information to the management server 130. The management server 130 may receive the processing request information from the face authentication server 120.

At step 660, the application may output the indication information based on the result of face authentication performed for the user using the face authentication result information.

The application may output the indication information based on the result of face authentication performed for the user to the output unit of the mobile terminal 110 using the face authentication result information. The output unit may be a display.

For example, the result of face authentication may be success of face authentication or failure of face authentication.

For example, the application may output indication information of the face authentication result information. When the indication information is output, the mobile terminal 110 may output an image that can be used for a specific purpose, and the output image may be used for the specific purpose.

For example, the application may output the user information included in the face authentication result information. When the user information is output, the mobile terminal 110 may represent the name, the post, the identity, or the privileges of the user, and the mobile terminal 110 may be used as the employee ID card of the user or the pass of the user.

For example, the application may output the system control information included in the face authentication result information. When the system control information is output, the mobile terminal 110 may be used in order to make a specific device of the system 100 perform a specific operation.

At step 665, the application may control the mobile terminal 110 using the face authentication result information.

For example, the application may enable or disable a specific function of the mobile terminal 110 using the terminal control information.

At step 670, the management server 130 may perform user management and/or control of the system 100 based on the processing request information.

For example, the management server 130 may process specific management for the user using the processing request information.

For example, the management server 130 may control a specific device of the system 100 so as to perform a specific operation using the processing request information.

For example, the management server 130 may control the speaker 160 of the system 100 so as to output a message using the processing request information. For example, the message may be a message for requesting the user to take a specific action (for example, to enter or exit through the access control device 140), or may be a guidance announcement about an organization.

Step 665 and step 670 may be included in the above-described step 420, or may be included in step 430.

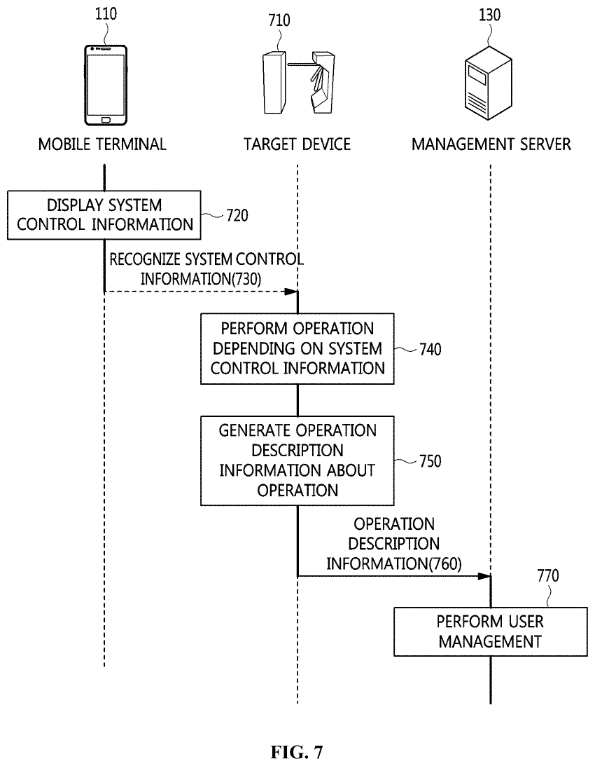

FIG. 7 may illustrate a system for controlling a device of a system based on face authentication performed for a user according to an embodiment.

In FIG. 7, the target device 710 of the system 100 may be a specific device, which is the target of control represented by the system control information.

For example, the target device 710 may be the access control device 140 or the user device 170.

Step 430, described above with reference to FIG. 4, may include the following steps 720, 730, 740, 750, 760 and 770.

At step 720, the application on the mobile terminal 110 may output the system control information included in the face authentication result information.

The application may output requestor identification information along with the system control information. The requestor identification information may be the identifier of the user or the mobile terminal 110. That is, the requestor identification information may indicate the user or the mobile terminal 110 that requests the target device 710 to perform a specific operation.

At step 730, the target device 710 may recognize the system control information output from the mobile terminal 110.

The target device 710 may recognize the requestor identification information along with the system control information.

At step 740, the target device 710 may perform the specific operation based on the system control information by recognizing the system control information.

For example, the target device 710 may perform the specific operation represented by the system control information by recognizing the system control information.

At step 750, the target device 710 may generate operation description information about the performed operation.

The operation description information may include 1) mobile terminal identification information, 2) target device identification information, and 3) operation information.

The target device identification information may represent the identifier of the target device 710.

The operation information may be information about the operation performed by the target device 710. For example, the operation information may include information that represents the operation performed by the target device 710. Also, the operation information may represent the time at which the target device 710 performs the operation.

At step 760, the target device 710 may transmit the operation description information to the management server 130. The management server 130 may receive the operation description information from the target device 710.

At step 770, the management server 130 may manage the user of the mobile terminal 110 using the operation description information.

The management server 130 may manage the user who is specified in the operation description information depending on the operation performed by the target device 710 represented by the operation description information.

Characteristics of Face Authentication Technology

The mobile terminal 110 or the face authentication server 120 may improve face authentication performance through the following characteristics and the like:
Using a parallel cascade face detector, a face may be quickly detected with high precision even when a camera is not directed at the front of the face.
An algorithm for extracting a face that is robust to image-quality issues may be used.
A face may be quickly detected using parallel processing by a multicore or multiprocessor system.
A face may be quickly detected in video through a method of extracting a changing area based on a keyframe.
High face recognition performance may be provided by giving a weight to an important facial feature point.
After a face is extracted, the face may be recognized in 3D.
A profile is predicted from a frontal facial image, whereby the recognition rate for a distorted face may be improved.
For a profile within a specific angle, whether the profile is the face of the same person may be detected.

Here, the extraction of a face may mean the extraction of a facial feature point.

In an embodiment, when face authentication for a user is performed, other biometric information of the user, such as the fingerprint of the user, the voice of the user, and the like may be additionally used. Such biometric information may be additionally used when face authentication is not performed normally or when the face authentication server 120 determines that the accuracy of face authentication is equal to or less than a specific baseline. The face authentication server 120 may transmit a request for additional biometric information to the mobile terminal 110, and the mobile terminal 110 may transmit biometric information of the user other than the face information, which is acquired through a microphone, a fingerprint recognizer, and the like, to the face authentication server 120. The face authentication server 120 compares the received biometric information with the biometric information of the user that is stored in the face authentication server 120 as the registration information, thereby performing additional authentication for the user.

Some of the functions of the application according to an embodiment may be provided in the form of a software development kit (SDK). The SDK may provide a function to capture an image or video, a function to extract facial feature points, and the like. Through the SDK, an application tuned or optimized for the organization using the system 100 may be provided.

Generation of Face Information through Mobile Terminal

One of the distinctive characteristics of the embodiment is the fact that face information is generated by a mobile terminal 110 carried by a user. Accordingly, the embodiment may have the following characteristics.

Because face information is generated through the application on the mobile terminal 110, the load on the face authentication server 120 may be reduced, and face authentication may be quickly processed.

Also, because face information is generated through the application on the mobile terminal 110, face information may be generated using the newest, state-of-the-art hardware (e.g., multiple cameras for a specific function) and software, and the face information may be used by a face recognition algorithm that is tuned and optimized for the hardware.

Also, because face information is generated through the application on the mobile terminal 110 managed by the user, the personal information of the user may be protected.

Also, because face information is generated through the mobile terminal 110, it is possible for multiple mobile terminals 110 in a limited area to simultaneously request face authentication from the face authentication server 120.

Also, because face information is generated through the application on the mobile terminal 110, a relatively small amount of data may be transmitted between the mobile terminal 110 and the face authentication server 120.

Also, because face information is generated through the application on the mobile terminal 110, the face information may be additionally used for systems other than the system 100 of the embodiment, and may be used for purposes other than face authentication. That is, the application may be used for general purposes. When image-capture-related parameters and the like are configured in the application for other purposes, the configuration may also be used for face authentication in the system 100.

Also, the mobile terminal 110 of the user may be easily connected with the conventional face authentication system, other authentication systems, or an access control/management system.

Also, multiple applications may be selectively used for a single system 100. A large number of applications may be competitively developed depending on the characteristics of the mobile terminal 110, and a user may select a suitable application from among them.

Control of Mobile Terminal using Authentication Result Information

As described above, the face authentication server 120 may transmit terminal control information to the mobile terminal 110 as the result of face authentication. The application may enable or disable a specific function of the mobile terminal 110 using the terminal control information. That is, the function of the mobile terminal 110 may be remotely controlled through the terminal control information. Also, the system administrator may monitor the state of control through the terminal of the system administrator.

For example, according to the security policy of an organization, the application may lock or unlock the mobile terminal 110 using the terminal control information.

For example, according to the security policy of the organization, the application may disable or enable a capture or recording function of the mobile terminal 110 using the terminal control information.

For example, according to the security policy of the organization, the application may disable or enable the sound output function of the mobile terminal 110, set the volume of sound output to 0, or set the volume to the previous value before being set to 0 using the terminal control information.

For example, according to the security policy of the organization, the application may restrict the use of a specific program, such as a messenger, a web application, a social network service (SNS) application, or the like, or may remove the restriction.

For example, according to the security policy of the organization, the application may disable or enable a specific network function, such as Wi-Fi, a mobile communication network, Bluetooth, or NFC.

For example, when the user enters or leaves a specific place through the access control device 140, a specific function of the mobile terminal 110 may be enabled or disabled using the terminal control information.

The enabled or disabled state may be maintained under the condition specified by the terminal control information, and may be effective while the specified condition is satisfied. The condition may be a specific period or the state in which the mobile terminal 110 of the user is located within a specific area.

For example, when the disabled specific function is enabled by a user, the application may notify the face authentication server 120 of the fact that the specific function is enabled. Also, when the enabled specific function is disabled by the user, the application may notify the face authentication server 120 of the fact that the specific function is disabled.

Execution of Application Based on Entry into Authentication Area

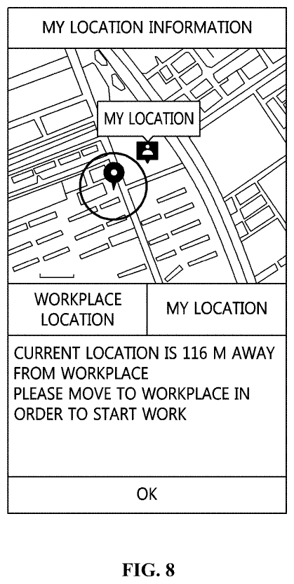

FIG. 8 illustrates location information displayed on a mobile terminal according to an example.

In FIG. 8, the location of the mobile terminal 110 ('my location') and the location of a workplace (marked with a symbol in the circle), which corresponds to the entity using face authentication, are illustrated, and an authentication area (indicated by the circle), in which face authentication is performed, is illustrated.

As described above with reference to FIG. 4, the mobile terminal 110 may receive an application execution signal from a beacon 190 when it enters a specific authentication area.

In another embodiment, the application execution signal may be a GPS signal output from a Global Positioning System (GPS).

The mobile terminal 110 may determine whether the mobile terminal 110 is located within a specific authentication area using the received GPS signal. When it is determined based on the GPS signal that the mobile terminal 110 is located within the specific authentication area, the mobile terminal 110 may execute the application.

The GPS signal may be used for a relatively large area, for example, a construction site. In contrast, the beacon 190 may be used for a relatively small area, for example, the inside of a building.

As illustrated in FIG. 8, the mobile terminal 110 may display and provide the location of the mobile terminal 110 using a GPS signal, and may display and provide the location of the organization performing face authentication and the location of the authentication area for face authentication. Also, the mobile terminal 110 may display and provide the distance from the location of the mobile terminal 110 to the location of the organization, and may display and provide information about movement to a place at which face authentication is required.

In an embodiment, the face authentication area may be a circular area, as shown in FIG. 8. Alternatively, the authentication area may be a polygonal area. Alternatively, the authentication area may be the area occupied by the facilities of the organization that performs face authentication, such as a building, a campus, or the like.

Area Information Based on Authentication Area

The face authentication server 120 may be used for multiple targets. That is, the face authentication server 120 may perform face authentication for users of multiple organizations, in which case it is necessary to identify the organization for which face authentication is to be performed.

For example, the organization may include a company, a workplace, a business site, an institution, a school, an educational institute, an association, a building, a specific floor in a building, and the like.

These different organizations may be identified based on the area in which the mobile terminal 110 is located. That is, when the mobile terminal 110 is located in a specific area, face authentication should be performed for the organization located in the specific area.

In order to represent the area in which the mobile terminal 110 is located, area information may be used. The area information may be information that is used in order to specify the area in which the mobile terminal 110 is located.

The authentication request information, described above with reference to FIG. 6, may include area information. When the mobile terminal 110 located in a specific area requests face authentication from the face authentication server 120, the mobile terminal 110 may generate authentication request information including the area information and transmit the same to the face authentication server 120.

The face authentication server 120 may specify the area in which the mobile terminal 110 is located using the area information, and may identify the organization for which face authentication is to be performed, among the multiple organizations provided with authentication service from the face authentication server 120, depending on the specified area.

The area information may be included in an application execution signal output from other devices, such as a beacon 190, a GPS satellite, and the like. That is, the mobile terminal 110 may receive the application execution signal including the area information, and may extract the area information from the application execution signal.

For example, the area information may be the identifier of the beacon 190. Using the identifier of the beacon 190, the face authentication server 120 may identify the organization in which the beacon 190 is disposed or the organization using the beacon 190 as the organization to be provided with face authentication service.

For example, the identifier of the beacon 190 may be the MAC address of the beacon 190.

For example, the area information may be the major value and the minor value of the beacon 190.

The area information may have a different format and/or different information depending on the device that generates an application execution signal or the device type and OS of the mobile terminal 110.

For example, the area information may be a GPS signal or the location of the mobile terminal 110 indicated by the GPS signal. Using the location of the mobile terminal indicated by the GPS signal, the face authentication server 120 may identify the organization located in the corresponding location as the organization to be provided with face authentication service.

Control of System Device using System Control Information

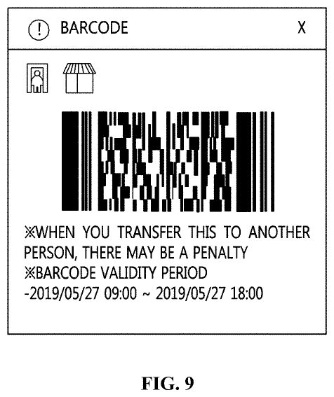

FIG. 9 illustrates system control information displayed on a mobile terminal according to an example.

In FIG. 9, a 2D barcode is illustrated as the system control information.

As described above, the system control information may be used to control the target device 710 of the system 100.

Also, the system control information may include a message related to the system control information. In FIG. 9, a message saying “when you transfer this to another person, there may be a penalty” is illustrated.

Also, the system control information may include validity period information representing a validity period during which the system control information is valid. In FIG. 9, “2019/05/27 09:00-2019/05/27 18:00” is illustrated as the validity period.

For example, the system control information may be generated using a time-based One-Time Password (OTP) method, and may represent a time-based OTP.

The system control information may be used in order to control the target device 710 of the system only during the period indicated by the validity period information. When the validity period has passed, the system control information may be ignored by the target device 710, or the target device 710 may output information indicating that the validity period has passed.

Also, the system control information may be one-time information. For example, the system control information may include a system control information identifier.

For example, the target device 710 of the system 100 may ask the management server 130 whether the system control information is valid before performing an operation based on the system control information, and may perform the operation only when the management server 130 gives a response saying that the system control information is valid. When the target device 710 of the system 100 operates based on the system control information, the target device 710 may transmit operation description information to the management server 130, in which case the operation description information may include the system control information identifier. Then, through the system control information identifier, the management server may recognize that the system control information was used, and may register the same as information that is no longer valid for all of the devices of the system 100.

Control of Gate

As described above, the system control information may be access certification information for operating the access control device 140.

The access certification information may be information for opening the gate of the access control device 140 of the system 100.

At the above-described step 730, the access control device 140 may recognize the access certification information output from the mobile terminal 110. At step 740, the access control device 140 may open the gate by recognizing the access certification information.

At step 750, the access control device 140 may generate operation description information. The operation description information may include 1) the identifier of the access control device 140 or the gate, 2) the identifier of the user, 3) operation information indicating that the gate is open, 4) the time at which the access control device 140 operates, and the like.

Control of User Device

The system control information may control the user device 170. For example, the user device 170 may be a personal electronic locker, a health diagnostic device, or the like.

The access certification information may be information for opening the electronic locker.

At step 730, the personal electronic locker may recognize the system control information output from the mobile terminal 110. At step 740, the personal electronic locker may open the door thereof by recognizing the system control information.

At step 750, the personal electronic locker may generate operation description information. The operation description information may include 1) the identifier of the personal electronic locker, 2) the identifier of the user, 3) operation information indicating that the personal electronic locker is open, 4) the time at which the personal electronic locker operates, and the like.

Face Recognition Live Check Combined with Motion of User

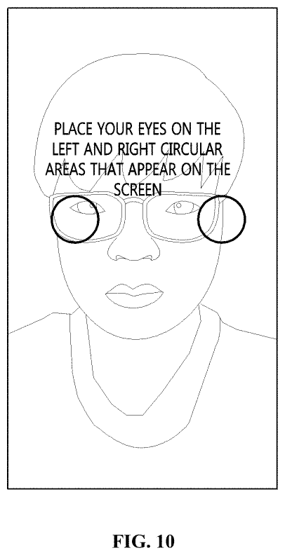

FIG. 10 illustrates a motion instruction message for face recognition, which is displayed on a mobile terminal, according to an example.

When face information is generated, if the use of a fixed image or unlimited replay of video is allowed, fraud may occur. For example, when face authentication is based only on a full-face image, the photograph of another person may be illegally used, whereby face authentication may be wrongly performed for the other person.

At the above-described step 620, when it generates face information, the application on the mobile terminal 110 may use face recognition combined with the motion of the user.

For example, the application may instruct the user to make a specific motion and check whether the user made the specific motion. When the application confirms that the user made the specific motion, face information pertaining to the face of the user may be generated through face recognition using the captured image or video.

In FIG. 10, a message instructing a user to move such that the two eyes are, respectively, placed on the left and right circular areas on a screen is displayed. That is, the specific motion may be aligning the pupils of the user with a guideline.

That is, at step 620, the application may output, via the output unit of the mobile terminal 110, a message instructing the user to make a specific motion.

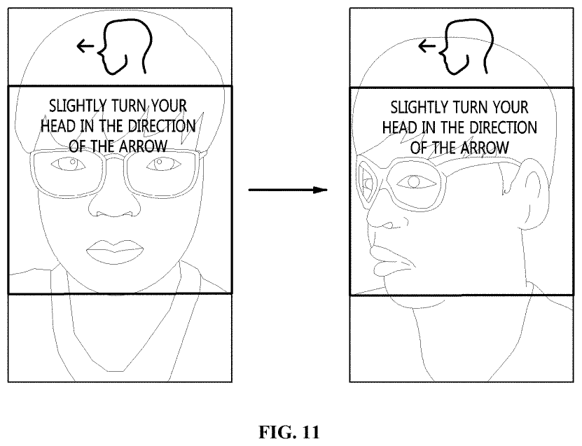

FIG. 11 illustrates another motion instruction message for face recognition displayed on a mobile terminal according to an example.

In FIG. 11, a message that instructs a user to turn the face in the direction of the arrow as the above-described specific motion is displayed. For example, the direction may be a specific direction, such as the left, the right, or the like.

Also, such a specific motion may include “to blink the eyes of the user”, “to move the mobile terminal 110 or the head of the user such that a specific part in the face of the user, such as an iris, an ear, and the like, looks bigger”, and the like.

At step 620, the application may perform face recognition for the user using the image before the user makes the specific motion as instructed and the image after the user makes the specific motion as instructed.

Alternatively, at step 620, the application may perform face recognition for the user using images captured at different angles depending on the motion of the user.

Through face recognition combined with the motion of the user, fraud using only a photograph and the like may be prevented, high-quality images of the face of the user may be acquired, and face recognition may be more accurately performed using these images.

Face Authentication in which Administrator or User Intervenes

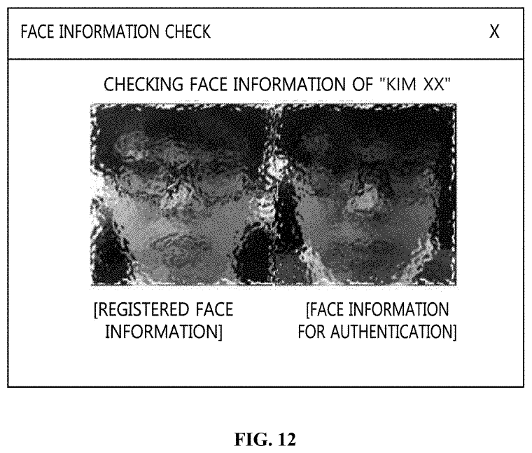

FIG. 12 illustrates a face information check screen according to an example.

With regard to face recognition, the following problems may occur:
1) The face of the user may not be consistent. For example, the face of the same person may look different before and after applying makeup.
2) Like identical twins, the faces of different people may look similar.

In this case, at step 640, the face authentication server 120 may compare the face information in authentication request information with registration information of the user. When face authentication for the user is performed through the comparison, the similarity between the face represented by the face information and the face represented by the registration information may not reach 100%.

If face authentication is performed in such a way that face authentication is determined to succeed only when the similarity between the face represented by the face information and the face represented by the registration information is 100%, face authentication may produce an excellent effect, but the recognition rate may drop. Also, it may be difficult to solve this face authentication problem only through the face authentication technique performed by the face authentication server 120.

In order to solve this problem, when face authentication is performed at step 640, the administrator of the system 100 or the user of the mobile terminal 110 may intervene therein.

When the similarity between the face represented by the face information and the face represented by the registration information falls within a predefined range, the face authentication server 120 may transmit face check information to the terminal of the system administrator or the mobile terminal 110.

The face check information may include information about faces matched by the face authentication server 120.

For example, the face check information may include the photograph of the registered face information and that of the face information for authentication, which are matched by the face authentication server 120. Here, the fact that the photograph of the registered face information matches that of the face information for authentication may indicate that the face authentication server 120 determines that the similarity therebetween falls within the predefined range.

Also, for example, the face check information may include the similarity between the registered face information and the face information for authentication that match each other.

Also, for example, the face check information may include the affiliation, the name, the identifier, and the like of the user of the mobile terminal 110 that transmitted the authentication request information.

The terminal of the system administrator or the mobile terminal 110 may output the face check information. For example, the photograph of the registered face information and the photograph of the face information for authentication may be displayed on the terminal of the system administrator or the mobile terminal 110 using the face check information.

Here, the registered face information may represent the face image of the registration information registered in the face authentication server 120. The face information for authentication may represent the face image of the face information included in the authentication request information transmitted from the mobile terminal 110.

In an embodiment, when the photograph of the registered face information and the photograph of the face information for authentication are displayed, specific image processing, such as blurring or the like, may be applied thereto. Such specific image processing may be used in order to protect personal information.

The system administrator or the user of the mobile terminal 110 may check whether the photograph of the registered face information and the photograph of the face information for authentication are photographs of the same person (or the person involved) and input the result to the terminal of the system administrator or the mobile terminal 110. The terminal of the system administrator or the mobile terminal 110 may transmit same-person check information generated based on the checking result to the face authentication server 120. When the same-person check information indicates that the two photographs are of the same person, the face authentication server 120 may determine that face authentication for the user has succeeded and perform steps after step 640. When the same-person check information indicates that the two photographs are not of the same person, the face authentication server 120 may determine that face authentication for the user has failed.

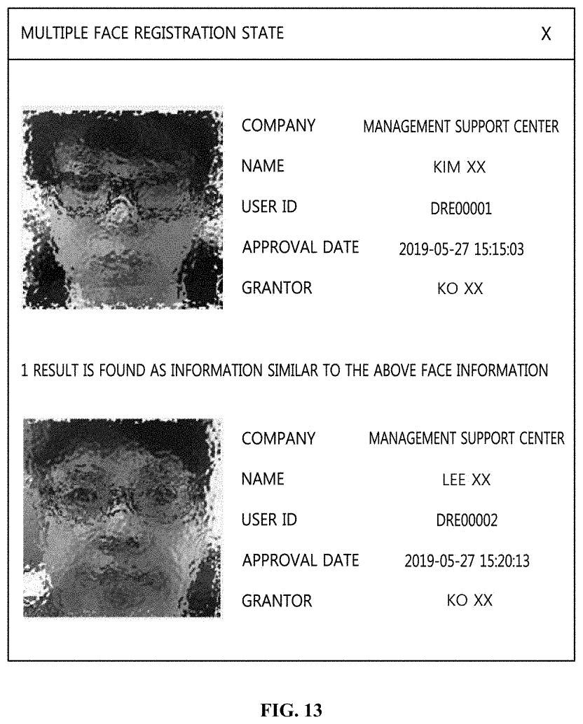

FIG. 13 illustrates a screen on which a multiple face registration state is displayed according to an example.

As described above, when face authentication is performed at step 640, the administrator of the system 100 or the user of the mobile terminal 110 may intervene therein.

When multiple faces, among faces represented by pieces of registration information of the multiple users of the system 100, satisfy the condition in which the similarity with the face represented by the face information falls within the predefined range, the face authentication server 120 may transmit multiple-face check information to the terminal of the system administrator or the mobile terminal 110.

The multiple-face check information may include information about the face images of the pieces of registration information of the multiple users that are determined by the face authentication server 120 to be similar to the face represented by the face information. That is, the multiple-face check information may be a report on photographs that are similar to the face represented by the face information, which are acquired through a comparison therewith, among the faces represented by the pieces of registration information of the multiple users.

For example, the multiple-face check information may include the photographs of the registered face information matched by the face authentication server 120.

Also, for example, the multiple-face check information may include the photograph of the face information for authentication.

Also, for example, the multiple-face check information may include the affiliation, the name, and the identifier of each of the users corresponding to the registered pieces of face information that are determined to match, and may also include the approval date and the grantor related to the user. The approval date may be the date on which the photograph of the face information is approved as the photograph of the corresponding user. The grantor may be the person who affirms that the photograph of the face information is a photograph of the corresponding user.

The terminal of the system administrator or the mobile terminal 110 may output the multiple-face check information. For example, the photograph of the face information for authentication and the photographs of the registered pieces of face information that match the photograph of the face information for authentication may be displayed on the terminal of the system administrator or the mobile terminal 110 using the face check information.

Here, the registered face information may be the face image of the registration information registered in the face authentication server 120.

When the photographs of the registered pieces of face information and the photograph of the face information for authentication are displayed, specific image processing, such as blurring or the like, may be applied thereto. Such specific image processing may be used in order to protect personal information.

The system administrator or the user of the mobile terminal 110 may select the photograph that represents the same person as the person shown in the photograph of the face information for authentication, among the photographs of the registered pieces of face information, and may input the selection to the terminal of the system administrator or the mobile terminal 110. The terminal of the system administrator or the mobile terminal 110 may transmit same-person selection information generated through the selection to the face authentication server 120. The face authentication server 120 may determine that face authentication for the user shown in the photograph represented by the same-person selection information has succeeded and perform steps after step 640.

Management for User Through Face Authentication and Control System

The system 100 described in the above embodiment may be used for user management.

At the above-described step 670, the management server 130 may manage the user.

For example, user management may be time and attendance management for the user

As described above, the authentication request information described above with reference to FIG. 6 may include area information, and the area information may be information that is used in order to specify the area in which the mobile terminal 110 is located.

In an embodiment, the processing request information transmitted at step 655 may include area information, and the management server 130 may confirm the fact that the user stayed in a specific area at a specific time using the area information. The management server 130 may generate attendance-related information about attendance of the user using the area information and store the same. For example, the management server 130 may record the fact the user arrives at work or leaves work using the area information.

For example, the attendance-related information may be information that represents the attendance of the user. The attendance-related information may represent whether the user arrives at work on a specific date, the work location, the time at which the user arrives at work, and the time at which the user leaves work.

From this aspect, the beacon 190 is capable of verifying that the user of the mobile terminal 110 stayed in a specific area or place at a specific time.

That is, the system 100 of the embodiment may be used as means for verifying that the user stayed in a specific area or place at a specific time by collectively using the mobile terminal 110 carried by the user, face recognition technology, and the area information.

In an embodiment, the management server 130 may generate attendance-related information about the attendance of the user using the operation description information transmitted at step 760 and store the same.

For example, when the access control device 140, which is the target device 710 of the system, transmits operation description information to the management server 130, the management server 130 may determine the time at which the user arrives at work or the time at which the user leaves work using the time at which the access control device 140 operates, which is included in the operation description information.

Also, using the identifier of the gate included in the operation description information, the management server 130 may identify whether the gate is an entry gate or an exit gate of the workplace, thereby checking whether the user arrives at work or leaves work.

Also, the management server 130 may check where the user is located using the identifier of the gate in the operation description information.

Generation of Thumbnail Image Through Face Authentication

At the above-described step 640, when face authentication for the user is successfully performed, the face authentication server 120 may generate a thumbnail image for the user using the authentication request information.

The thumbnail image may be the result of face authentication. The thumbnail image may be a photograph or image that shows the face of the user.

When face authentication of the user is successfully performed, the face authentication server 120 may use the captured image included in the authentication request information as the thumbnail image. That is, the thumbnail image may be recognized as the most recent image of the user.

The face authentication server 120 may store the thumbnail image as the registration information pertaining to the user. The thumbnail image may replace the existing image in the registration information, or may be used as the registration information for the next face authentication along with the existing image.

By managing the thumbnail image, the most recent photograph of the user may be used for face authentication for the user, and the thumbnail image may also be used for a document to be described later.

Generation of Document Using Face Authentication

At the above-described step 670, the management server 130 may generate a document by controlling the target device 710 of the system 100. The document may be an electronic document or a document printed on a physical medium, such as paper or the like.

For example, the target device 710 may be a printer 150.

For example, the document may be a document related to the attendance of the user. Also, the document may be a document related to work of the user, such as an employment contract, a pledge, or the like.

For example, the document may be a time and attendance report that shows the time at which the user arrives at work, the time at which the user leaves work, and the like, and may include the hourly wage of the user, a salary calculated based on working hours, and the like.

For example, the printed document may be output by the printer 150.

For example, the printed document may be a pass or a meal ticket.

The printed document may be recognized by a recognizer, and may be used for the service related to the system 100.

The document may include the thumbnail image of the user. The thumbnail image may be used in place of a handwritten signature, a digital signature, or the like for the document. The thumbnail image may prevent the user from denying the authenticity of the document or prevent the user from denying that the user has anything to do with the document, whereby the authenticity of the document may be verified.

Use of Substitute Device

Depending on the circumstances, the user may not carry a mobile terminal 110. In preparation for such a case, the system 100 may include a dedicated terminal, a dedicated printer, and a dedicated card, which are substitute devices that substitute for the functions of the mobile terminal 110.

The dedicated terminal, the dedicated printer, and the dedicated card may be devices exclusively used for face authentication and control performed by the system 100.

The dedicated terminal may perform an operation in order to replace the function of the above-described mobile terminal 110. That is, the mobile terminal 110 may be replaced with the dedicated terminal in the above-described embodiment.

The dedicated terminal may be a personal computer, a tablet PC, or the like.

The dedicated terminal must be shared so as to be used for multiple users, rather than being carried by a single user. Therefore, it may be undesirable to output indication information via the dedicated terminal. When face authentication for the user is performed through the dedicated terminal, the dedicated printer may print the indication information on the paper so as to replace the mobile terminal 110. The indication information printed on the paper may be used in place of the indication information displayed on the mobile terminal 110. The dedicated card may output system control information in place of the communication unit of the mobile terminal 110.

The device described herein may be implemented using hardware components, software components, and/or a combination thereof. For example, the device and components described in the embodiments may be implemented using one or more general-purpose or special-purpose computers, for example, a processor, a controller, an arithmetic logic unit (ALU), a digital signal processor, a microcomputer, a field-programmable array (FPA), a programmable logic unit (PLU), a microprocessor, or any other device capable of executing instructions and responding thereto. The processing device may run an operating system (OS) and one or more software applications executed on the OS. Also, the processing device may access, store, manipulate, process and create data in response to execution of the software. For the convenience of description, the processing device is described as a single device, but those having ordinary skill in the art will understand that the processing device may include multiple processing elements and/or multiple forms of processing elements. For example, the processing device may include multiple processors or a single processor and a single controller. Also, other processing configurations such as parallel processors may be available.

The software may include a computer program, code, instructions, or a combination of one or more thereof, and may configure a processing device to be operated as desired, or may independently or collectively instruct the processing device to be operated. The software and/or data may be permanently or temporarily embodied in a specific form of machines, components, physical equipment, virtual equipment, computer storage media or devices, or transmitted signal waves in order to be interpreted by a processing device or to provide instructions or data to the processing device. The software may be distributed across computer systems connected with each other via a network, and may be stored or run in a distributed manner. The software and data may be stored in one or more computer-readable storage media.

The method according to the embodiments may be implemented as program instructions executable by various computer devices, and may be recorded in computer-readable storage media.

The computer-readable storage media may include information that is used in the embodiments of the present disclosure. For example, the computer-readable storage media may store a bitstream, and the bitstream may include information described in the embodiments of the present disclosure.

The computer-readable storage media may include a non-transitory computer-readable medium.

The computer-readable storage media may individually or collectively include program instructions, data files, data structures, and the like. The program instructions recorded in the media may be specially designed and configured for the embodiment, or may be readily available and well known to computer software experts. Examples of the computer-readable storage media include magnetic media such as a hard disk, a floppy disk and a magnetic tape, optical media such as a CD-ROM and a DVD, and magneto-optical media such as a floptical disk, ROM, RAM, flash memory, and the like, that is, a hardware device specially configured for storing and executing program instructions. Examples of the program instructions include not only machine code made by a compiler but also high-level language code executable by a computer using an interpreter or the like. The above-mentioned hardware device may be configured so as to operate as one or more software modules in order to perform the operations of the embodiment, and vice-versa.

Using a face authentication platform provided by the embodiment, the face of a user may be easily and quickly recognized, whereby authentication may be easily and quickly performed.

Based on the solution or service provided by the embodiment, the convenience of an administrator and a user may be improved, and the efficiency of work may be improved.

Although the embodiments of the present disclosure have been disclosed for illustrative purposes, those skilled in the art will appreciate that various modifications, additions and substitutions are possible, without departing from the scope and spirit of the present disclosure. For example, if the described techniques are performed in a different order, if the described components, such as systems, architectures, devices, and circuits, are combined or coupled with other components by a method different from the described methods, or if the described components are replaced with other components or equivalents, the results are still to be understood as falling within the scope of the present disclosure.

What is claimed is:

1. An authentication method in which a mobile terminal of a user performs authentication for the user by operating in conjunction with a face authentication and control system, comprising:
generating face information for the user by capturing an image of the user;
transmitting authentication request information including the face information to a face authentication server; and
receiving face authentication result information from the face authentication server,
wherein the face authentication result information represents a result of the face authentication for the user.

2. The authentication method of claim 1, further comprising:
installing an application for face authentication;
generating registration information for the face authentication based on information about the user, which is input from the user through the application; and
transmitting the registration information to the face authentication server.

3. The authentication method of claim 1, further comprising:
executing an application when the mobile terminal receives an application execution signal.

4. The authentication method of claim 3, wherein:
the application execution signal is a beacon signal output from a beacon, and
the mobile terminal receives the beacon signal from the beacon when the mobile terminal enters a specific authentication area in which it is possible to receive the beacon signal.

5. The authentication method of claim 3, wherein:
the application execution signal is a GPS signal output from a GPS, and
the mobile terminal executes the application when it is confirmed through the GPS signal that the mobile terminal is located in a specific authentication area.

6. The authentication method of claim 1, wherein:
the authentication request information further includes area information, which is information that is used in order to specify an area in which the mobile terminal is located, and
the face authentication server specifies the area in which the mobile terminal is located using the area information and determines an organization for which the face authentication is to be performed depending on the specified area.

7. The authentication method of claim 1, further comprising:
outputting indication information based on the result of the face authentication for the user using the face authentication result information,
wherein:
the face authentication result information includes the indication information, and
the indication information is information that is required to be output via the mobile terminal depending on whether the face authentication for the user succeeds or fails.

8. The authentication method of claim 7, wherein:
the indication information includes user information, and
the user information represents a name, a post, an identity, or a privilege of the user.

9. The authentication method of claim 7, wherein:
the indication information includes system control information, and
the system control information is information for controlling a specific device of the face authentication and control system.

10. The authentication method of claim 1, wherein the mobile terminal uses face recognition combined with a motion of the user when the face information is generated.

11. An authentication method in which a face authentication and control system performs face authentication for a user by operating in conjunction with a mobile terminal of the user, comprising:
receiving, by a face authentication server, authentication request information including face information about a face of the user of the mobile terminal from the mobile terminal;
performing, by the face authentication server, face authentication for the user using the authentication request information; and
generating, by the face authentication server, face authentication result information for the face authentication and/or processing request information based on a result of the face authentication,
wherein:
the face authentication result information is information representing the result of the face authentication for the user, and
the processing request information is information for requesting management for the user and/or control of the face authentication and control system when the face authentication for the user succeeds.

12. The authentication method of claim 11, wherein a system administrator of the face authentication and control system or the user intervenes in the face authentication when the face authentication server performs the face authentication.

13. The authentication method of claim 11, further comprising:
transmitting, by the face authentication server, the processing request information to a management server; and
performing, by the management server, the management for the user using the processing request information,
wherein the management is time and attendance management for the user.

14. The authentication method of claim 11, further comprising:
transmitting, by the face authentication server, the processing request information to a management server,
wherein the management server generates a document by controlling a target device of the face authentication and control system.

15. The authentication method of claim 11, further comprising:
recognizing, by a target device, system control information of the face authentication result information output from the mobile terminal; and
performing, by the target device, a specific operation depending on the system control information.

16. The authentication method of claim 15, further comprising:
generating, by the target device, operation description information about the specific operation;
transmitting, by the target device, the operation description information to the management server; and
performing, by the management server, the management for the user using the operation description information.

17. The authentication method of claim 16, wherein the management server generates attendance-related information about attendance of the user using the operation description information and stores the generated attendance-related information.

18. The authentication method of claim 11, wherein the face authentication server generates a thumbnail image for the user using the authentication request information when the face authentication for the user is successfully performed.

19. A computer-readable recording medium in which a program for performing the method of claim 1 is recorded.
